(19) United States
(12) Patent Application Publication
(10) Pub. No.: US 2026/0349585 A1
(43) Pub. Date: Nov. 5, 2026

(54) HOLISTIC VISUALIZATION OF SOFTWARE TOKENS

(71) Applicant: SAP SE, Walldorf (DE)

(72) Inventor: Florian Handt, Dresden (DE)

(73) Assignee: SAP SE, Walldorf (DE)

(21) Appl. No.: 19/196,468

(22) Filed: May 1, 2025

(51) Int. Cl. G06F 3/0484; G06F 3/0481

(52) U.S. Cl. CPC G06F 3/0484; G06F 3/0481; G06F 2203/04806

(57) ABSTRACT

Methods and apparatus are disclosed for unified visualization of software tokens from a software environment. An unordered collection of tokens is extracted from the environment, along with a network or relationships among the tokens. Tags are applied to the tokens, which are placed in a space based on the tags and relationships. Additional tokens are synthesized and placed amidst the pre-existing tokens. A zoomable visualization of the space is rendered, which can render increasing detail as zoom magnification is increased. Workflows and dataflows can be rendered. Customizable filtering and links to specialized software applications can be supported. Disclosed techniques provide homogeneous implementation across an enterprise, reducing labor required to develop and maintain custom interfaces for each specific job function.

### BACKGROUND

Enterprise architectures-including software environments-grow progressively more complex. Procedures and data used in one segment of the enterprise often evolve independently of other segments, despite one segment's procedures commonly relying on data or procedures of another segment, and vice versa. Users of the software environment interact with software through a variety of user interfaces, often relying on a visualization according to the task at hand. However, visualization tools are often function-specific and therefore may not readily extend to other functions or other segments of the enterprise. Maintenance and continual development of new tools for new functions can be burdensome. Accordingly, there remains a need for a unified architecture for visualization across any given software environment.

### SUMMARY

Examples of the disclosed technologies provide techniques to implement a unified architecture for visualization across a hierarchical environment, based on software tokens. In one aspect, a sea of software tokens is extracted from a hierarchical software environment, along with a network of relationships among respective groups of the software tokens. One or more tags are assigned to each of the software tokens, which are then placed in a space based at least partly on the assigned tags and at least partly on the extracted relationships. Additional software tokens are synthesized and placed at positions intermediate between previously placed tokens (which can include both tokens extracted from the software environment and synthesized tokens). A zoomable visualization of the space is rendered, providing increasing detail with increasing zoom.

The foregoing and other objects, features, and advantages of the invention will become more apparent from the following detailed description, which proceeds with reference to the accompanying figures.

### BRIEF DESCRIPTION OF THE DRAWINGS

FIG. 1 is a flowchart of a first example method for visualizing related software tokens according to the disclosed technologies.

FIGS. 2A-2B are flowcharts illustrating example extensions to the first method.

FIG. 3 is a diagram illustrating an example hierarchical software environment to which disclosed technologies can be applied.

FIG. 4 is a diagram illustrating an example software environment of an automobile manufacturer, to which disclosed technologies can be applied.

FIG. 5 is an illustration of an example visualization generated according to the disclosed technologies.

FIGS. 6A-6B are diagrams illustrating an example content cluster with which disclosed technologies can be applied.

FIG. 7 is a diagram illustrating an example content cluster derived from the software environment of FIG. 4.

FIG. 8 is a diagram illustrating example zoom features of visualizations according to the disclosed technologies.

FIGS. 9A-9B are diagrams illustrating example variations of flows, according to the disclosed technologies.

FIG. 10 is a diagram schematically depicting a computing environment suitable for implementation of disclosed technologies.

FIG. 11 is a diagram schematically depicting computing devices operating in conjunction with a computing cloud for implementation of disclosed technologies.

### DETAILED DESCRIPTION

### Introduction

As enterprise software environments grow more complex, the user interface tools used to support various job functions proliferate. A common paradigm is for tools to be developed independently for each job function, multiplying the costs incurred for development and maintenance. Most tools entail visualization of some procedure or data components of the software environment. Disclosed technologies provide a unified approach to the visualization which can be applied across the entire software environment of an enterprise, or any segment thereof.

Many software environments can be organized in layers, leading to a hierarchy of tokens within the environment. However, the pre-existing hierarchy can be restrictive and often less helpful than desired in fostering evolution of software processes. Disclosed technologies can break a rigid structure imposed by pre-existing hierarchy, allowing for flexible placement of software tokens in relation to one another. Disclosed technologies also support synthesis of additional software tokens, e.g. to fill gaps between tokens that may be some distance from one another in a virtual space. The synthesized tokens enable incremental variations in software procedures that may not have been possible within the pre-existing software hierarchy. Synthesized tokens also provide smoother user experience in zoom operations, naturally appearing or disappearing as zoom varies, while maintaining a consistent density of entities rendered on a display.

Disclosed visualizations support rendering overlaid graphs of workflows or dataflows. Pan, tilt, and zoom support intuitive exploration of the software environment. Customizable filters enable a user to focus on aspects relevant to a job at hand. Additionally, the visualization can support clicking on a software token or attached tag to jump to a specialized software application for that token.

### Terminology

To facilitate review of the various embodiments, the following explanations of terms are provided. Occasionally, where clear from the context, a term may also be used in a different meaning.

“Classify” and “classification” refer to an act of assigning an item to one or more of a finite predetermined set of categories, each of which is dubbed a “class”. A software program performing classification is termed a “classifier” and can be a trained machine learning tool.

The unqualified term “data” refers to any digital representation of information. “Data items” are data entities whose values convey particular meaning in a software environment.

A “flow” is a sequential arrangement of software entities (such as software tokens). The software entities can be regarded as nodes of a directed graph. Some flows are linear, and can have the entities arranged in a line, e.g. without branches or merges: each entity in the flow immediately following at most one other entity, and each entity in the flow immediately followed by at most one other entity. But this is not a requirement, and other flows can have joins, whereby one software entity has two or more immediate precursors, or can have forks, whereby one software entity can have two or more immediate successors. In a graph representation, the node of a software entity can be joined to its immediate precursor(s) or successor(s) by respective edges of the graph. Two types of flows of interest herein are “workflows”, in which the software entities are procedures, and “dataflows” in which the software entities are data items. To illustrate, a workflow can be a sequential arrangement of procedures which collectively accomplish a given task. In some examples, the node immediately preceding a given procedure can be a prerequisite which can be required before the given procedure can be performed, but this is not a requirement. In other examples, two independent procedures can be placed one before the other in the workflow. As another illustration, a dataflow can be a sequential arrangement of data items which can be determined successively along the dataflow, e.g. by calculation. Similar to workflows, an upstream node in a dataflow can be a prerequisite for determining a downstream node, but this is not a requirement. Still further flows can be hybrid flows, combining procedure nodes and data nodes in any combination. To illustrate, a procedure can generate one or more first data items. One or more second data items can be provided as inputs to a second procedure. While some flows are directed acyclic graphs, this is not a requirement. Other flows can include cycles (e.g. iterative procedures, or iterative data calculations). Flows can include branch nodes (e.g. evaluation of a stopping condition for an iterative loop).

A “graph” is a set of two or more nodes and a set of one or more edges joining respective pairs of the nodes. The edges can be directed (e.g. where one node is dependent on another node, often represented with single-ended arrows), and the graph is dubbed a “directed graph.” Other edges can be undirected. A “path” follows successive edges of the graph. The graphs described herein are often directed graphs. Directed or undirected edges can be traversed from one node to the next to form a “path.” Two portions of a graph having no paths between them are termed “disjoint.” A graph is a logical structure and can be implemented using any of various types of data structures to track nodes and edges (e.g. linked lists, arrays). A graph or a graph data structure can be a model of other entities (such as software tokens) and the relationships therebetween. The graphs described herein can be represented or stored as a data structure, and the term graph extends to such a data structure.

A “hypergraph” is a generalization of a graph in which a single edge can join more than two nodes. That is, a hypergraph is a set of two or more nodes and a set of one or more edges joining respective groups of the nodes. Other properties and terminology of a graph are similarly applicable to a hypergraph.

A “hierarchy” is an arrangement of entities (such as software tokens) over a plurality of layers. Each entity can be present on exactly one of the layers. Often, the layers can have significance within an associated software environment. A software entity can be coupled to another software entity on a same or different layer. Commonly, a software entity is directly coupled to one or more software entities in adjacent layers. To illustrate, an entity on a higher layer (a “parent” entity) can be dependent on, composed of, or implemented by one or more entities on an adjacent lower layer (“child” entities). An entity on a lower layer can be part of, or relied on by one or more entities on a higher layer. The hierarchy can be represented as a graph or hypergraph, with entities as nodes and direct coupling relationships as edges. In some examples, the hierarchy can include one or more trees, in which each lower layer child entity has a single parent entity on a higher layer, up to a root node at a highest layer. In other examples, a given child entity can have multiple parent entities. Still further, coupling may not be restricted to entities on adjacent layers. Some software entities can be directly coupled to entities in the same layer or in more distant layers. In other examples, the layers may not be ordered, and the concept of adjacency can be absent.

An “interactive” software application presents intermediate output to a client, receives input in response, and proceeds according to the received input. The client can be a user station, but this is not a requirement. In other examples, the client can be another software program, which can variously be a deterministic or heuristic supervisor program; an agentic artificial intelligence tool; or another trained machine-learning tool. “Machine learning” (“ML”) denotes a technique for improving performance of a software program through experience (dubbed “training”). Machine learning can change data (e.g. weights, parameters, or coefficients) used by the software program without changing the program's instructions. An “ML tool” is a software program trained by an ML technique. A neural network is an example of a software tool that can be trained by machine learning. A trained machine learning tool can include trained parameters, instructions to perform calculations on input data using the trained parameters to obtain output data, and supervisory program code to manage input and output interfaces, activate the calculations, update trained parameters, collect or provide diagnostic information, or perform other tasks. A “parameter” is an atomic data item (such as a weight applied to a given input to a given cell of a neural network) within an ML tool. Parameter values can be established by training, to obtain desired behavior. The behavior of a trained ML tool can variously be governed by: its trained parameters, other configuration data, and associated resources. A “configuration” of an ML tool can include an environment in which the ML tool operates (e.g. for training, testing, or inference), as well as variables (other than trainable parameters) controlling the ML tool itself or its interfaces with its environment. “Render” refers to an act of transforming underlying data into a form suitable for display. Rendering can include selection of some material to be displayed, among available material; mapping of selected material into display elements; geometric, color, or grayscale transformations; or mapping display space positions onto display pixels.

A “sea” is an unordered collection of objects (such as software tokens). In some examples, a sea can prohibit duplicate objects, like a set, while in other examples, duplicates can be permitted, like a bag or multiset.

“Software” refers to computer-executable programs or instructions and associated data structures. Software can be in active or quiescent states. In an active state, software can be loaded into memory or undergoing execution by one or more processors. In a quiescent state, software can be stored on computer-readable media, awaiting transmission or execution. “Launch” refers to an act of transitioning software from a quiescent state to an active state.

A “software application” (or, simply, “application”) is a computer-executable program performing functions for one or more clients. Additionally, some applications can operate without client users, e.g. launched by a supervisor or another application, performing tasks autonomously or in an event-driven mode. That is, the client of a software application can be another application. An application can include both executable instructions (dubbed “code” or “program code”) and non-executable data (dubbed “application data” or “program data”). A software application can include one or more software processes and can be executed on a single computer or distributed over multiple computing systems.

A “software environment” refers to a collection of software processes (e.g. programs), data objects (including e.g. databases and configuration files), and/or associated requirements available at a site. The site can be a single location (e.g. a user's computer or an organization's data center) but this is not a requirement, and some sites can be distributed over e.g. multiple users, multiple data centers, and/or one or more cloud providers. The software environment can include a description of associated hardware, such as terminals or network interfaces through which the software environment can be accessed.

A “software token” is a unit of procedure(s), data item(s), and/or requirement(s) in a software environment or an indicia thereof. A procedure token can be coupled to data token(s) and requirement token(s). That is, a software token often incorporates just one among: procedure(s), data item(s), or requirement(s), but this is not a requirement. To illustrate, a trained ML tool can incorporate both program instructions (e.g. procedure) and trained parameters (e.g. data) and can be represented as a single software token. As another illustration, a procedure (e.g. program instructions) can be bundled with its functional requirement in a single software token. Moreover, some software tokens can represent (in a software environment), physical operations or physical objects, allowing these physical operations or physical objects to interact with software entities or with each other. A “relationship” between two or more tokens indicates that the tokens can work together (also encompassing one token being a possible substitute for one or more other tokens) and defines their respective roles. Many types of relationships can exist between software tokens. To illustrate, a requirement token R1 and a procedure token P1 token can have a can-be-implemented-by relationship, thus: R1 can-be-implemented-by P1. A procedure token P2 and a data item tokens D2, D3 can have needs-input and generates-output relationships respectively, thus: P2 needs-input D2, P2 generates-output D3. Still further, requirement R2, procedure P3, and data items D4, D5 can all be related together, along one edge of a hypergraph, as a cluster. Some software tokens can be pre-existing within a software environment. Traversal of the software environment allows these tokens to be identified and extracted. Other software tokens can be synthesized based on the pre-existing or extracted tokens. Thus, token “synthesis” refers to creation of a software token that was not previously present in the software environment. A variety of techniques can be used for token synthesis, including interpolation, extrapolation, generalization, speciation, and extension. To illustrate, two data items D6, D7 having respective numerical values 10 and 20, for a common variable, allow interpolation to obtain data item D8 with corresponding value 14, and allow extrapolation to obtain data item D9 with corresponding value 25. Two data items D10, D11 describing a slotted screwdriver and a Philips screwdriver, allow generalization of D12 as a turning tool, and speciation of D13 as a hexagonal Allen key. Procedures P10, P11 to fasten two objects with slotted screwdriver (D10) and Philips screwdriver (D11) respectively, can be extended to generate a token for procedure P13 using the hexagonal key D13. Examples of the disclosed technologies can apply tags to software tokens. A “tag” is a metadata item indicating a property of the software token to which it is attached. Software tokens can be classified in various aspects, and the tags can indicate the associated classes. In varying examples, tags can be used to indicate whether a given software token is a procedure, data, requirement, a composite, or another type of software token. Tags can be used to indicate from which layer of a hierarchy a software token was obtained, or on which layer of a 2.5-D space the software token is to be placed. Tags can be used to indicate e.g. that data objects D10, D11, D13 are all members of the genus D12. An organization's software environment can be organized over multiple regions for respective departments or functional areas, and a tag can indicate the region from which the software token was obtained. Still further, tags can be used to differentiate pre-existing and synthesized software tokens. Inasmuch as disclosed technologies can process software tokens, tags can also be used to indicate the processing state of a token.

A “space” is an expanse in one or more dimensions. Points within a space can be defined on a continuum or on a discrete grid, in any combination. Some examples of the disclosed technologies generate a visualization for a two-dimensional (2-D) display. Commonly, tokens can be arranged on a 2-D space for straightforward rendering or can be arranged in a 3-D space and the visualization can be a projection of the 3-D space onto a 2-D display. In further examples, a finite number of 2-D spaces can be implemented (e.g. one for each layer of a hierarchy). A “2.5-D” space can be such a collection of, often, two to twenty 2-D spaces. Entities (such as software tokens) can be assigned positions in the space. The entity can be assigned to a single point or to a finite extent of the space, independently in each dimension. Here, a point has zero extent, and “finite” extent means an extent greater than zero in at least one dimension of the space. Moreover, the extent can be sufficient to correspond to multiple pixels at the highest magnification of the visualization is capable. Thus, an extent of 10⁻¹⁰ (arbitrary units), which corresponds to 10⁻⁴ pixels at a highest magnification, would not be considered to be a finite extent.

“Speciate” refers to an act of creating a new species of a genus. While the genus is often identified prior to creating the new species, this is not a requirement. To illustrate, a new species can be created from sibling species without explicitly identifying their common genus.

A “user interface” (“UI”) is hardware or software enabling a user or other agent to interact with a computer system or software application. A user interface can be a “graphical user interface” (“GUI”), which is an interface on which a software program can visually display data or other objects to a user, combined with one or more input devices via which the user can provide input to the software program responsive to the visual display. Alternatively, an application programming interface (“API”), a text-mode console, voice response or other interfaces can also be used as a UI. Input provided through a UI is dubbed “user input.” A portion of a UI is said to have “focus” if (1) input from a user will be directed to that portion, or (2) the user's attention is drawn to output from that portion. The portion of the UI can variously be a software application (among several applications sharing the UI), a window, a UI element (such as a text box or a drop-down menu), or a specified region of the UI. While focus is often associated with one UI element at a time, this is not a requirement. In other examples, multiple portions of the UI can have focus simultaneously—to illustrate, mouse and keyboard inputs can be directed to different portions of the UI, and another two portions of the UI can be displayed with blinking to attract the user's attention.

A “visualization” is a rendering of a representation of information (such as software tokens) in a visual form. A visualization can include images, graphical symbols, other graphical output, or text, in any combination. “Zoom” is an operation on a visualization of a space that can increase or decrease magnification of all or part of the space being displayed. Increasing zoom means increasing magnification and, often, retaining a lesser portion of the space within the display (smaller field of view). Reducing zoom means decreasing magnification and, often, incorporating a greater portion of the space onto the display (larger field of view). As zoom is increased, the amount of display area available, for a given region of the underlying space, also increases. Examples of the disclosed examples can use this area in different ways. Detail can be increased (1) by increasing the fraction of tokens displayed from the given region, (2) adding labels, annotation, or other structure to the visualization of a given token, or (3) illustrating more relationships of the given token. A point representation of a software token can be replaced by a representation having size proportional to the spatial extent of the software token. In further examples, a visualization can be filtered according to one or more user-selected criteria or according to zoom. Examples of filtering can be used to control which, or what fraction, of software tokens to display; to control which layers of a 2.5-D space to display; to control the level of detail or annotation to be rendered in conjunction with a software token; or to control which relationships to include in the visualization.

### Example Method

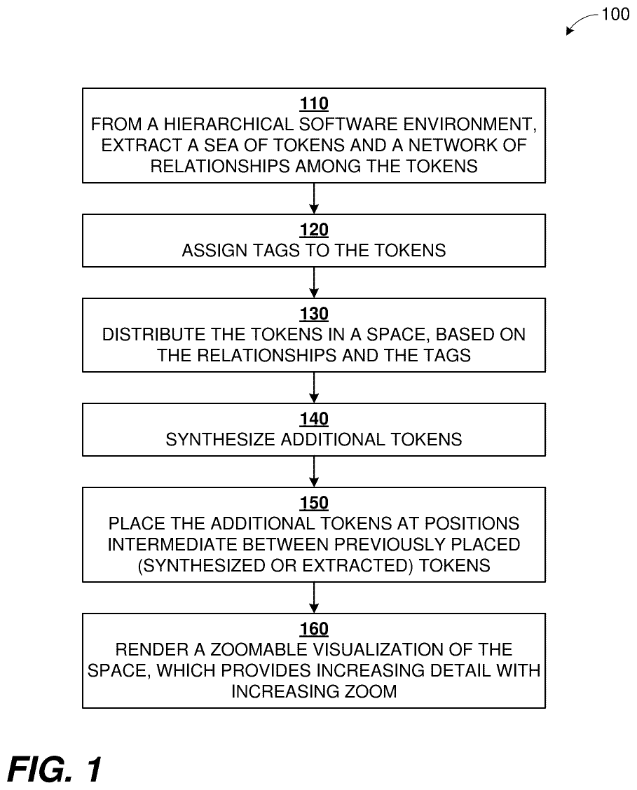

FIG. 1 is a flowchart 100 of a first example method for visualizing related software tokens. In this method, software tokens are extracted from a software environment and placed in a space, along with additional synthesized tokens. A zoomable visualization of the space is rendered.

At process block 110, a sea of software tokens is extracted from a hierarchical software environment, along with a network of relationships among respective groups of the software tokens. The software tokens can be identified and extracted by traversing the software environment in any manner. In some examples, layers can be traversed by independent tasks, each task collecting the software tokens on its respective layer. In other examples, a top-down traversal can be implemented. A top layer of the hierarchy can be traversed and, for each software token on the top layer, all coupled, associated, or constituent software tokens on successive lower layers can be collected before proceeding to the next top layer token. In further examples, a similar bottom-up traversal can be implemented. For each software token on a bottom layer, all coupled, associated, or dependent software tokens on successive higher layers can be collected before proceeding to the next bottom layer token. Inasmuch as some software environments may be partitioned into segments, e.g. according to divisions or sites of an organization, each such segment can be traversed independently. In some examples, each extracted software token can be a data structure containing an identifier of the token and one or more links to the original body of the software token in the software environment, to a schema in which the token is defined, or other descriptive metadata of the token. In other examples, the extracted software token can be a copy of the original software token in entirety. As described herein, a variety of relationships can be defined for pairs or larger groups of software tokens, and these can be extracted as a network (e.g. graph or hypergraph). That is, the software tokens can be regarded as nodes of a graph or hypergraph. According to the type of relationship, a binary relationship can be represented as a directed or undirected edge of a graph or (where other ternary or higher order relationships are present) hypergraph. N-way relationships, for positive integers N>2, can be represented as hypergraph edges.

At block 120, one or more tags are assigned to each of the software tokens. As described herein, each tag can variously indicate a source (e.g. layer or segment of a software environment), type, class, or status of the token to which it is assigned.

At block 130, the extracted software tokens are placed in a space based at least partly on the assigned tags and at least partly on the extracted relationships. To illustrate, tokens of a common type or class can be placed in proximity within the space, or tokens from a given layer of a hierarchy can be placed on a corresponding layer of a 2.5-D space. Additionally, related tokens on respective layers can be placed in proximity to one another, or even overlapping. A distance minimization algorithm can be used to determine optimal relative placements.

At block 140, additional software tokens are synthesized. Because pre-existing software tokens can be sparsely distributed over a given space, it can be desirable to augment the extracted preexisting tokens with similar synthesized tokens. As described herein, tokens can be synthesized, for example by interpolation, extrapolation, generalization, speciation, or extension. In one aspect, the synthesized tokens can occupy intermediate positions among pre-existing tokens in a visualization, improving the homogeneity of the visualization and avoiding a user having to mentally fill in gaps in the visualization. In another aspect, synthesized tokens at a given level can provide additional insights and new implementations of a token at a higher level. In a conventional software development paradigm, the presence of one implementation of the higher-level token can be sufficient, and development of a new implementation can be laborious. In the present paradigm, the synthesis of new tokens can be fully or largely automated, and generation of a new implementation (using the synthesized token) from an old implementation can be performed simply, using the visualization.

At block 150, the additional software tokens are placed at positions intermediate between previously placed tokens (“tokens” including both tokens extracted at block 110 and additional tokens synthesized at block 140). Such placement can improve homogeneity of the visualization and lead to discovery of new implementations, as described herein.

At block 160, a zoomable visualization of the space is rendered, providing increasing detail with increasing zoom. Tokens positioned in the space can be rendered with optional extent, as predetermined symbols or shapes. Tokens on different layers of the space can occlude one another with selectable degrees of transparency, opacity, or shadows. As zoom is increased, the number of tokens in a given displayed region of the space can also increase; or the detail associated with displayed tokens can increase. As zoom is decreased, the number of tokens in a given displayed region of the space can also decrease. Detail or even entire layer(s) of the space can be omitted. The zoom can be operated by a GUI control such as a scroll wheel, a slider, or up/down buttons. Other controls can allow the visualization to be panned across the space, tilted, or azimuthally rotated. Further controls can change detail items included in the visualization.

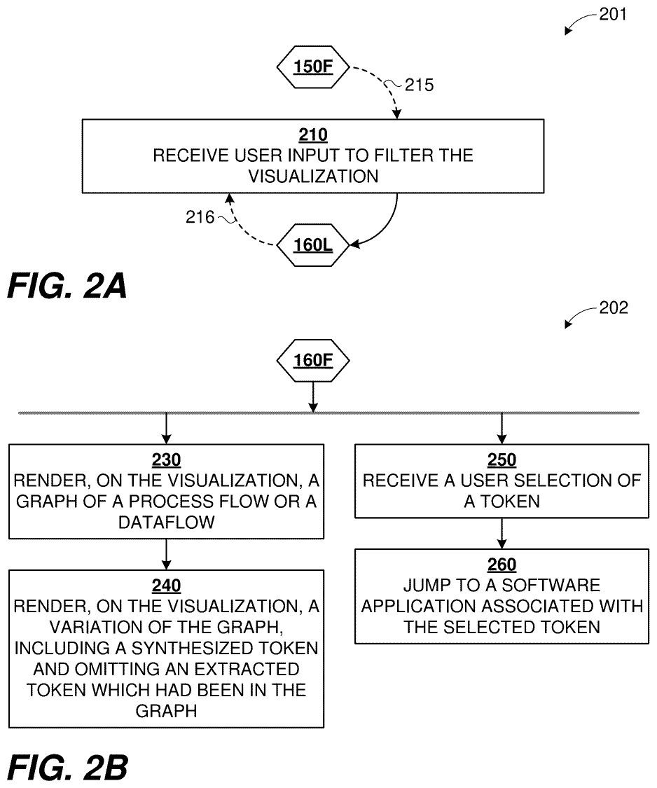

Numerous variations and extensions can be implemented within scope of the disclosed technologies, some of which are described in context of FIG. 2.

FIGS. 2A-2B are flowcharts 201-202 illustrating example extensions to the first method. In flowcharts 201-202, hexagon connectors 150F, 160F, 160L stand in for respective blocks 150, 160, 160 of FIG. 1, allowing the extension blocks of FIG. 2 to be shown in relation to elements of FIG. 1.

Starting with FIG. 2A, the method of FIG. 1 can be extended to support filtering the visualization. At process block 210, input from a user can be received, directing that the visualization be filtered according to one or more criteria. The extended method can proceed to block 160 of FIG. 1 (represented by hexagon connector 160L) where the visualization can be rendered, with filter applied. As indicated by dotted arrows 215, 216, block 210 can be reached in different ways. In some examples, filtering can be specified prior to visualization of the space, e.g. following block 150 via arrow 215. In variations, filtering can be specified prior to block 150. In other examples, filtering can be specified after the visualization has been rendered, e.g. via arrow 216. That is, filter specification at block 210 and rendering the visualization at block 160 can operate as an interactive loop.

As one example of filtering, visualized tokens can be restricted to tokens extracted from one or more selected layers of the hierarchical environment, optionally including tokens synthesized between these extracted tokens. A layer-wise filter can allow a user to focus on the occupancy of the selected layer(s), and can allow a user to specify locations or regions in the visualization where additional tokens can be synthesized. Tokens on some layers can represent machines or other classes of equipment, and the synthesized tokens can suggest additional machines or equipment to be deployed in the enterprise. As another example, the visualization can be restricted to software tokens implemented on one or more selected computing platforms, hardware and/or software. This can help a user to assess loads and plan for growth of the computing resources supporting the enterprise. As a third example, the visualization can be restricted to first software tokens along selected one or more flows, optionally including additional software tokens directly linked to the first tokens. This can assist a user in understanding components of the visualized flow(s).

Turning to FIG. 2B, some extensions are illustrated following block 160 of FIG. 1 (represented by hexagon connector 160F). Along the left-hand path in FIG. 2B, a graph of a workflow or a dataflow can be rendered on the visualization at block 230. In a further extension, a variation of this graph can be rendered on the visualization at block 240. The variation can include a synthesized token while omitting an extracted token from the original graph. In this way, the synthesized token can provide an alternative implementation of a higher layer token, as a new insight.

Along the right-hand path of FIG. 2B, a user selection of a visualized token can be received at block 250. Then, at block 260, a user interface UI1 associated with the visualization can jump to a software application A1 associated with the selected token. In some situations, this may entail launching application A1. In other situations, application A1 may already be active, and block 260 can transfer focus of UI1 to application A1.

Beyond FIG. 2, further extensions or variations can be implemented. In some examples, where the network of relationships extracted at block 110 is represented as a hypergraph, at least one edge of the hypergraph can join respective nodes of three or more of the software tokens. At least some of the assigned tags can indicate classes of the respective software tokens within the software environment. To illustrate, five of the tokens may represent a particular type of resource R1, and the tokens can belong to a class “Resource Type R1”. Then, each of these tokens can be assigned a tag indicating this class, e.g. “Resource Type R1”. Some tags can be assigned interactively, e.g. by a user. To illustrate, a user interested in a particular job function can visualize one or more workflows or dataflows associated with this job function, and can assign a specific (new) tag T1 to software tokens along these flows. Alternatively or additionally, tags can be assigned by a trained ML tool. To illustrate, the trained ML tool can be prompted to apply tag T2 to software tokens associated with a particular job function. The ML tool can then identify such tokens and assign tag T2 in a manner comparable to the user's interactive assignment of tag T1.

At least some of the tokens placed at blocks 1 can have respective finite extents in the space. The finite extent of a first placed token can overlap the position of a second placed token. The second placed token can have its own finite extent, or can be represented as a point in the space, having zero extent. The finite extents can be used as a basis for prioritizing the tokens retained in the visualization as the zoom is decreased. To illustrate, initially a group of tokens variously having zero or finite extents can all be visible. As zoom is decreased, zero-extent tokens can be removed from the visualization. As zoom is decreased further, tokens having extent greater than a threshold value can be retained, while tokens having smaller extent can be omitted. The threshold value can vary inversely as the zoom magnification. In some examples, as zoom decreases, rendering can prioritize display of the software tokens extracted at block 110 over tokens synthesized at block 140.

As described further herein, the visualization rendered at block 160 can be well suited for display of a graph of a workflow or a graph of a dataflow over a succession of the software tokens. Thus, a workflow can be represented as a graph whose nodes comprise the tokens representing successive acts of the workflow, and whose edges form a path representing the succession of these acts. Similarly, a dataflow can be represented as a graph whose nodes comprise the tokens representing data objects in the dataflow, and whose edges indicate the pairwise dependencies among these tokens.

Given a first graph (e.g. a workflow, a dataflow, or a hybrid flow) comprising at least a given extracted software token TE1, the disclosed technologies can identify alternatives to the first graph. For example, a variation of the first graph can be rendered on the visualization, the variation including a synthesized software token TS1 but omitting token TE1.

### Example Software Hierarchy

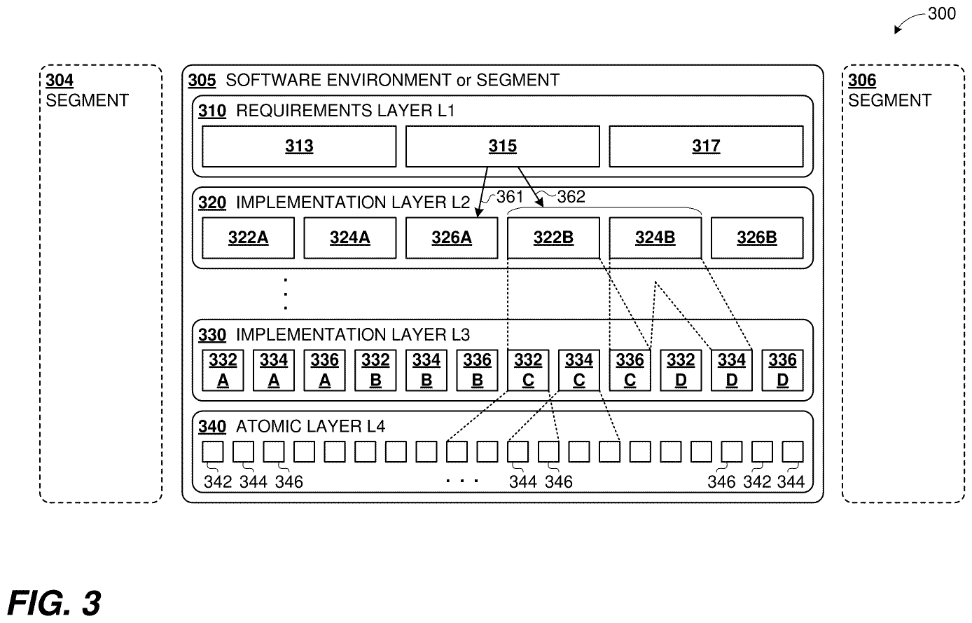

FIG. 3 is a diagram 300 illustrating an example hierarchical software environment 305. Four layers are illustrated, with Requirements Layer L1 310 at the top, Atomic Layer L4 340 at the bottom, and a stack of Implementation Layers L2 320 . . . L3 330 in between.

Requirements Layer 310 is shown with three requirements 313, 315, 317. Each requirement defines a high-level objective sought to be accomplished using components within software environment 305. To illustrate, some enterprise requirements can be “build a car,” “design a car,” “upgrade database,” or “run payroll.” Each requirement 313, 315, 317 can be a software token.

Each requirement in Layer 310 can have one or more implementations e.g. in next layer L2 320. Three types of implementation are shown in Implementation Layer L2 320: implementations 322 can be procedures, implementations 324 can be data objects, such as databases or data structures, and implementations 326 can be hybrid entities combining procedure components and data components. Each implementation 322, 324, 326 (two of each type are shown) can be a software token.

Arrow 361 indicates that Requirement 315 can be implemented by Layer L2 hybrid implementation 326A, while arrow 362 indicates that Requirement 315 can alternatively be implemented by a combination of Layer L2 procedure implementation 322B and data implementation 324B. For clarity of illustration, additional implementations of Requirements 313, 315, 317 are omitted from FIG. 3.

In turn, the implementations of Layer L2 320 can rely on building blocks from Implementation Layer L3 330. Like Layer L2 320, three types of implementations are shown for Layer L3 330: procedures 332, data 334, and hybrid 336. Dashed lines between layers L2 320 and L3 330 show that procedure implementation 322B can be implemented by a combination of Layer L3 implementations 332C, 334C, and 336C; while data implementation 324B can be implemented by a combination of hybrid implementation 336C and data implementation 334D.

At the base of hierarchy 305 is Atomic Layer 340, incorporating components (also software tokens) which are not (or need not be) decomposed into smaller constituents. Non-limiting examples of procedural atomic components 342 can include various creation, deletion, insertion operations, search and reporting functions, timing functions, or other low-level functions required by the implementations of Layer L3 330. Non-limiting examples of data atomic components 344 can include: configuration parameters, indexing or other working variables, identifiers, links to external data sources, or other low-level data items required by the implementations of Layer L3. Hybrid atomic components 346 can be analogous to hybrid implementations 326, 336. An exemplary hybrid component 346 can include an atomic procedure, an index or other working variable used by that procedure, and an identifier of a data object on which the procedure can be performed. Dashed lines indicate groups of atomic components on which implementations 332C and 334C rely.

Numerous variations and extensions can be implemented within scope of the disclosed technologies. In a variation, block 305 can be one segment within an enterprise software environment. The enterprise software environment can also include other segments 304, 306 as shown in dashed outline, each having a similar layer structure as shown for segment 305.

The layer architecture of environment/segment 305 is exemplary. Examples of the disclosed technologies may incorporate more or fewer than two implementation layers. Each layer shown can in turn be organized as a stack of two or more sub-layers, or can be partitioned horizontally according to function type, or data type, or according to a schema.

To illustrate, tokens in the Requirement Layer can sometimes be organized in one or more of the following classes: strategy, goal, value chain, program, specification, rules, product, channel, partner, resource, or location. Tokens in an Implementation Layer can sometimes be organized in one or more of the following classes: process, organizational unit, role, or competence. Tokens in an atomic layer can sometimes be organized in one or more of the following classes: application, information object, application programming interface (API), technology, information technology (IT) infrastructure, or rules. In further examples, a sub-layer of Atomic Layer L4 340 can include system resources, such as energy sources or equipment.

### Example Application to Automobile Manufacturer

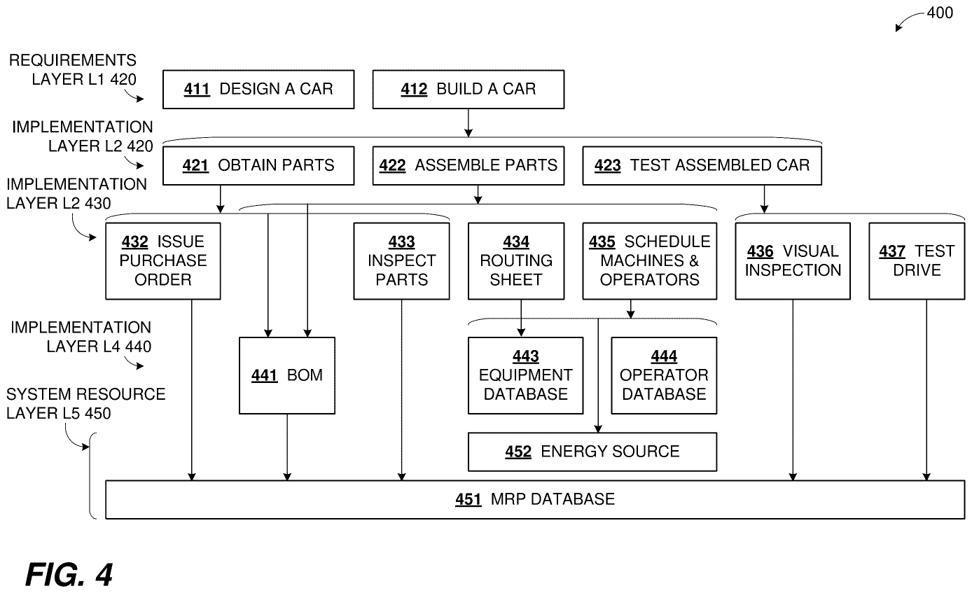

FIG. 4 is a diagram 400 illustrating an example software environment of an automobile manufacturer, to which disclosed technologies can be applied. In the context of automobile manufacturing, some of the tokens may have aspects which appear to represent physical world operations rather than software per se. However, a person of ordinary skill, armed with this disclosure, will recognize that even physical operations can be guided by software or can have results logged in software, so that all of the depicted blocks incorporate software components.

Five layers of software tokens are shown in FIG. 4. Requirements layer L1 410 and System Resource layer L5 450 are separated by three Implementation layers L2 420, L3 430, and L4 440.

Illustrated at the Requirements Layer 410 are two enterprise level requirements, namely 411 “Design a Car” and 412 “Build a Car.” Implementation Layer 420 shows a strategy for building a car, namely a workflow including 421 “Obtain Parts,” 422 “Assemble Parts,” and 423 “Test Assembled Car.” In turn, layers L3 430, L4 440 provide an implementation of token 421 “Obtain Parts,” relying on blocks 441 “BOM” (Bill Of Materials), 432 “Issue Purchase Order”, and 433 “Inspect Parts.” Each of these layer L3 430 and layer L4 440 blocks in turn relies on System Resource 451 “MRP Database,” MRP denoting Material Requirements Planning as customary in the art.

Token 422 can be implemented by tokens 441 “BOM,” 433 “Inspect Parts,” 434 “Routing Sheet” (describing the manufacturing steps required to assemble the car), and 435 “Schedule Machines and Operators.” As before, blocks 441 “BOM” and 433 “Inspect Parts” rely on MRP Database 451. Routing Sheet 434 relies on Equipment Database 443, and Scheduling block 435, which will result cause assembly steps from Routing Sheet 434 to be performed, relies on Equipment Database 443, Operator Database 444, and System Resource 452 “Energy Source” to power the assembly equipment.

Finally, token 423 “Test Assembled Car” can be implemented with blocks 436 “Visual Inspection” and 437 “Test Drive,” both of which in turn cause results to be logged in a Finished Good Inventory which can be part of MRP Database 451. MRP Database 451 provides an example of layer flexibility. While shown as a System Resource on Layer L5 450 in the illustrated segment, other segments in the enterprise may be concerned with implementation of MRP Database 451 and may show it at a higher layer, relying on lower layer tools or resources for management, maintenance, or updates.

### Example Visualization

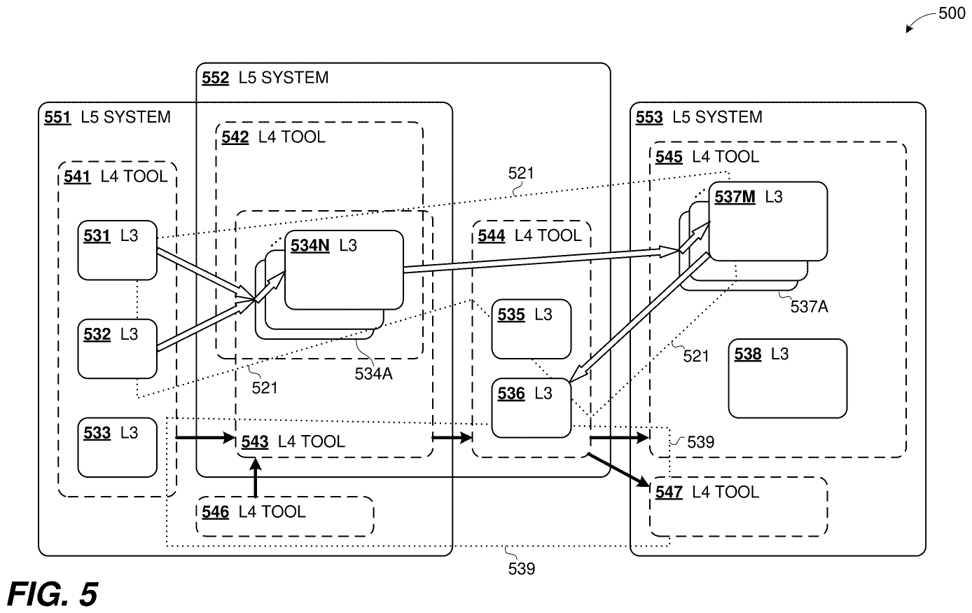

FIG. 5 is an illustration 500 of an example visualization generated according to the disclosed technologies. In this illustration, software tokens at three layers L3, L4, L5 are depicted as rectangles with rounded corners. For clarity of illustration, tokens on L4, the middle of these layers, are shown in dashed outline, while tokens on L3 and L5 are shown in solid outline. In FIG. 5, layers L4, L5 are tool (or application) and system resource sub-layers corresponding to one layer (Atomic Layer L4) in FIG. 3. Layer L3 is an Implementation Layer providing building blocks similar to L3 of FIG. 3. These layers are exemplary, and similar visualizations can be generated with other groups of layers.

At layer L4, software tokens of seven tools 541-547 are shown. These are placed over tokens of the system resources they require. Thus, tools 543-544 require system resources 551 and 552, while remaining tools 541, 544-547 each require just the one system resource over which they are placed. To illustrate, tool 541 requires system resource 551.

Tools 541-545 variously enable a number of Implementation building blocks on layer L3. Each L3 Implementation block can be a single process operation. Implementation blocks 531-533 rely on tool 541 and, accordingly, the corresponding tokens are depicted overlaid on token 541. Implementation blocks 534A-534N rely on both tools 542 and 543. Accordingly tools 542, 543 are shown overlapping, and Implementation blocks 534A-534N are shown placed in this overlap area. Similarly, Implementation blocks 535-536 are placed to show their dependence on tool 544, and Implementation blocks 537A-537M and 538 are placed to show their dependence on tool 545.

Often, a sequence of process operations can rely on the same prerequisites from lower layers, and the corresponding tokens can be visualized compactly in a stack, similar to a multi-story tower, or a deck of cards. In FIG. 5, sequential operations 534A-534N are shown as such a stack, as also operations 537A-537M. The stack arrangement of tokens can introduce an additional dimension in a visualization, turning a 2-D or 2.5-D planar visualization of the space into a 3-D visualization.

Open arrows in FIG. 5 also show a workflow, with initial operations 531, 532 preceding operation 534A; operation 534N followed by 537A; and operation 537M leading to final operation 536. Collectively, this workflow can capture an Implementation procedure at next higher level L2, as indicated by dotted line token 521. In some examples, open arrows and/or outline of token 521 can be rendered on the visualization.

Also shown in FIG. 5 are solid arrows of a dataflow. For clarity of illustration, the dataflow is shown along layer L4 tokens, but this is not a requirement. Flows can exist on any layer, and can also span tokens of different layers. In this illustration, data of tools 541, 546 are prerequisites for a data determination in tool 543, followed by another data determination in tool 544. Data from tool 544 independently enables data determination in tools 545, 547. Collectively, this dataflow can be an implementation of a token at a next higher level, illustratively Implementation procedure 539, shown as dotted outline. In some examples, the solid arrows and/or outline of token 539 can be rendered on the visualization.

Numerous variations and extensions can be implemented within scope of the disclosed technologies. Whereas FIG. 5 depicts Layer L5 System Resources 551-553 having large extent, with enough room to show multiple higher level tokens dependent on that System Resource, and progressively smaller spatial extent at higher layers L3, L4, this is not a requirement. In other examples, tokens at a top layer (e.g. Requirements Layer L1 310 of FIG. 3) can be shown with largest spatial extent, spanning all lower layer tokens on which they rely. Where necessary, lower layer tokens can be duplicated within each top layer token they support.

### Example Content Cluster

Implementations are at the heart of a software environment, utilizing tools and resources of lower layers to achieve the requirements of higher layers. A content cluster is a grouping of an Implementation Layer token with supporting tokens from lower layers. A content cluster represents a minimal grouping of software tokens for performing some work, namely the work of the Implementation Layer token, and can be a hypergraph edge. In some examples, token placement at blocks 130 or 150 of FIG. 1 can include identification of content clusters and co-placement of a cluster's constituent tokens.

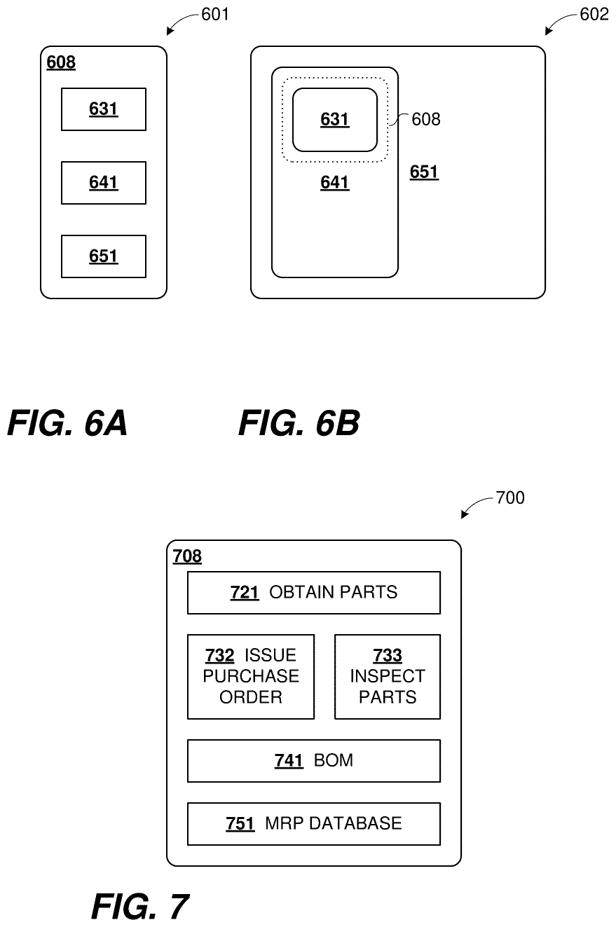

FIGS. 6A-6B show two views 601-602 of an example content cluster, in which Implementation block 631 relies on application 641 and in turn system resource 651. In this example, 631 does not make use of any other software tokens on lower layers. However, lower layer tokens 641, 651 can support other implementation blocks.

FIG. 6A depicts a content cluster 608 from a perspective of a software hierarchy similar to that shown in FIG. 3. Implementation block 631 on layer L3, application 641 on layer L4, and system resource 651, on layer L5, are shown positioned according to their respective layers.

FIG. 6B depicts the content cluster from a perspective of a visualization similar to that shown in FIG. 5. That is, tokens 631, 641, 651 are shown at their respective positions in a visualized space. Token 641 has additional extent to support additional implementation blocks on layer L3 (not shown). Token 651 is likewise extended to support additional tools on layer L4and/or additional implementation blocks on layer L3 (not shown). In FIG. 6B, the extent of content cluster 608 is shown defined by implementation block 631, so as not to inadvertently include other tokens that may rely on application 641 or system resource 651 but are otherwise independent of token 631.

FIG. 7 is a diagram 700 illustrating an example content cluster derived from the software environment of FIG. 4. Content cluster 708 provides a minimal grouping of software tokens for implementing procedure 721 “Obtain Parts.” Procedure 721 at layer L2 relies on layer L3Implementation blocks 732, 733, and BOM data object 741 from layer L4. All of these in turn rely on system resource 751 “MRP Database.”

### Example Zoom Features

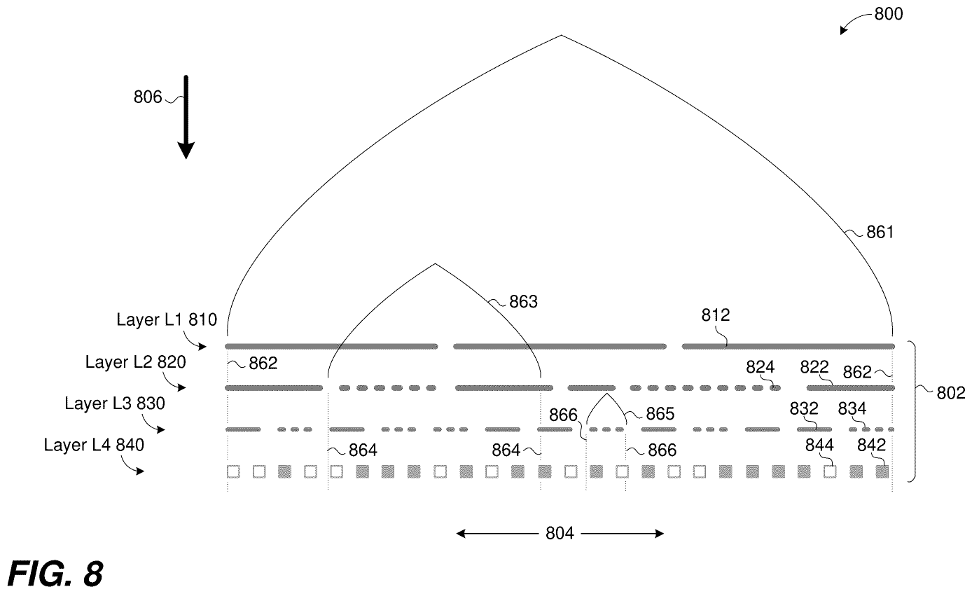

FIG. 8 is a diagram 800 illustrating example zoom features of visualizations according to the disclosed technologies. In this illustration, software tokens 802 are placed on multiple layers 810, 820, 830, 840 of a 2.5-D space 804. Tokens 812 are placed on layer L1 810, tokens 822, 824 are placed on layer L2 820, tokens 832, 834 are placed on layer L3 830, and tokens 842, 844 are placed on layer L4 840. Tokens 812, 822, 832 are extracted tokens and are depicted as solid lines, while tokens 824, 834 are synthesized tokens and are depicted as dashed lines. Similarly, on layer L4, solid squares 842 represent extracted tokens, while open squares 844 represent synthesized tokens.

Layers 810, 820, 830, 840 are described herein as similar to software hierarchy layers L1-L4 of FIG. 3, for convenience of description, but this is not a requirement: visualization layers need not correspond to layers or sub-layers of a software hierarchy, and can be selected or customized according to the purpose for which the visualization is being used.

A visualization can be generated with viewing direction indicated by arrow 806. Three markers 861, 863, 865 indicate fields of view bounded by dotted lines 862, 864, 866 for exemplary low, medium, and high magnifications, respectively.

Starting with low magnification, field of view 861 is large. The large extents of tokens 812 allows these tokens to be comfortably displayed at low magnification. Moreover, annotation for tokens 812 can also be displayed. Tokens 822, 824 can also be rendered according to their respective extents. Because the display area for each token 822, 824 is correspondingly less than for tokens 812, tokens 822, 824 can be rendered without annotation, or with less annotation than tokens 812. The greater number of tokens 832, 834 on layer L3 can lead to more crowding in the visualization, compared to layers L1 or L2. In some examples, tokens 832, 834 can be rendered as point objects, having a fixed size on the display irrespective of the actual extent they are assigned in space 804. In other examples, extracted tokens 832 can be retained in the low-magnification visualization, while synthesized tokens 834 can be omitted. Finally, tokens 842, 844 can be omitted altogether.

At medium magnification, field of view 863 is somewhat smaller than field of view 861. The field of view can span two tokens 812 or, in some scenarios, can lie wholly within a single token 812. Accordingly, the extent of tokens 812 may not be discernible. Tokens 812 can be indicated by a label or by background coloring. Field of view 863 is well suited to display tokens of layers L2 820, L3 830, and these can be rendered with varying amounts of annotation (or other detail). Tokens of layer L4 840 may crowd the available display. In some examples, only select tokens (e.g. extracted tokens 842) can be rendered, or tokens 842 and/or 844 can be rendered as point objects, irrespective of their extent in space 804.

At high magnification, field of view 865 is small. Tokens 812 can be omitted from the visualization. Tokens 822, 824 of layer L2 and tokens 832, 834 of layer L3 can be indicated by label or background shading, optionally with annotation for layer L3 tokens within field of view 865. Tokens 842, 844 within field of view 865 can be rendered according to their extent in space 804.

### Example Flow Variations

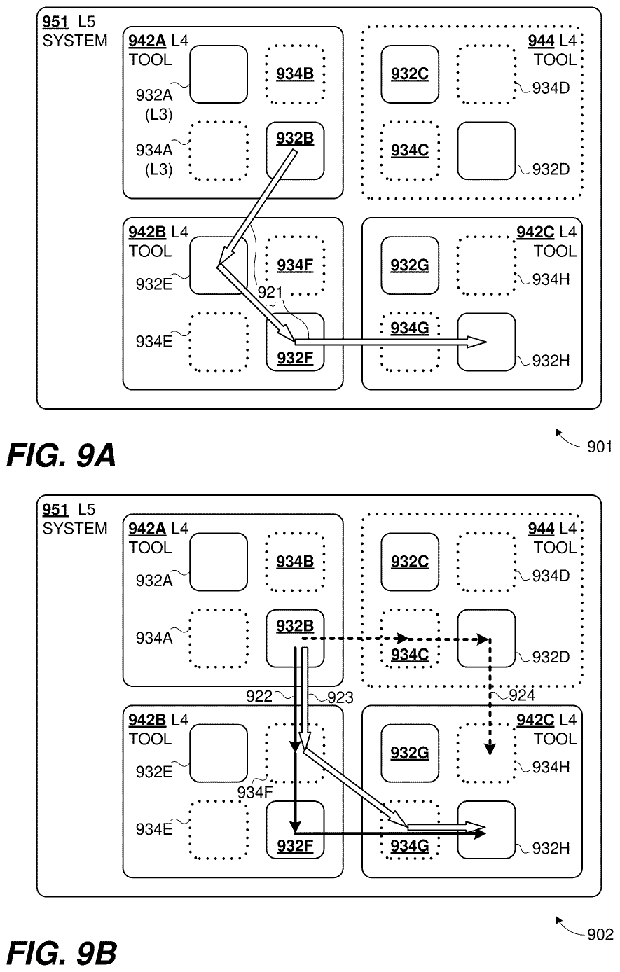

FIGS. 9A-9B are diagrams 901-902 illustrating example variations of flows. These variations propose alternatives to a pre-existing workflow using synthesized software tokens.

FIG. 9A is a visualization of a software environment, showing pre-existing Implementation blocks 932A-932H (solid outline) at layer L2 supplemented by synthesized tokens 934A-934H (dotted outline). Implementations blocks 932A-932H, 934A-943H variously rely on pre-existing tools 942A-942C at layer L4 or synthesized tool 944, all of which in turn rely on system resource 951 at layer L5. Notably, synthesized tool 944 can support both synthesized implementation blocks 942C-942D or pre-existing implementation blocks 932C-932D, in any combination. To illustrate, upon synthesis of tool 944, a pre-existing implementation block (e.g. 932C), dependent on another layer L4 tool (e.g. 942A), can be copied or moved to depend on synthesized tool 944.

In FIG. 9A, open arrows 921 designate a flow 932B→932E→932F→932H, following pre-existing implementation blocks at layer L3. Together this flow can be a pre-existing implementation of a layer L2 implementation block.

Turning to FIG. 9B, synthesized tokens can be used to propose flows 922-924 as alternates to flow 921. For clarity of illustration, different arrow styles are used for flows 922-924, and only one link in each flow is numbered. Flow 922 replaces pre-existing token 932E in flow 921 with synthesized token 934F. Flow 923 makes a further replacement of pre-existing token 932F with synthesized token 934G.

Flows 922-923 demonstrate incremental variations starting from pre-existing flow 921, but this is not a requirement. Flow 924 takes a divergent path from 932B to 932H, incorporating synthesized block 934C and pre-existing block 932D, both relying on synthesized tool 944, to end at 934H. That is, a variation of a flow need not share originating or destination points with the original flow.

Numerous variations and extensions can be implemented within scope of the disclosed technologies. Various techniques can be used to generate or evaluate flow variations. Flow variations can be made as random incremental variations, and then validated by checking that prerequisites are satisfied for each block along the varied flow. Similarly, where the flow endpoint is varied, as in flow 924, validation can include checking that the desired outcome of the flow is obtained. Flow variations can also be ranked according to a cost metric, such as total time, total energy consumption, or congestion (e.g. over-subscribed usage) at any node along the flow graph (e.g. at a corresponding software token).

As an illustration, given initially an existing flow, one or more candidate alternate flows can be generated following relationships linking successive tokens along a new (alternative) path between endpoint tokens of the existing flow. The relationships can be restricted to data relationships or procedure relationships according to the type of the existing flow. Additional alternative flows can be generated to/from an alternate endpoint that is equivalent to a corresponding endpoint of the existing flow. That is, an alternate starting endpoint can use a same or equivalent data item or perform a same or equivalent procedure as the starting endpoint of the existing flow. Conversely, an alternate termination endpoint can produce a same or equivalent data item or perform a same or equivalent procedure as the termination endpoint of the existing flow. Then, each candidate alternate flow can be validated, e.g. to ensure that prerequisites are met at each token along the candidate flow.

Validated alternate flows can be further evaluated. In some examples, a performance metric can be determined for an alternate flow, and the existing flow and alternate flows can be compared or ranked according to this metric. Non-limiting examples of metrics can measure e.g. computation cost, other cost, time, or congestion along the flow. In further examples, similarity of two flows (e.g. an alternate flow and the existing flow, or two alternate flows) can be determined. In some examples, it can be desirable for a flow to conform to a standard, e.g. for ease of upgrade or maintenance, and an alternate flow that has high similarity score with the existing flow can be preferred over a dissimilar alternative flow. In other examples, it can be desirable to have dissimilar alternate flows, e.g. for diversity in resource utilization and better resiliency to outages or congestion at computing or other equipment.

### Additional Examples

The following are additional examples of the disclosed technologies.

Example 1 is a method, including: with one or more computers: from a hierarchical software environment, extracting a sea of software tokens and a network of relationships among respective groups of the software tokens; assigning one or more tags to each of the software tokens; placing the software tokens in a space based at least partly on the assigned tags and at least partly on the extracted relationships; synthesizing additional software tokens; placing the additional software tokens at positions intermediate between previously placed tokens, the tokens including the extracted software tokens and the synthesized software tokens, collectively; and rendering a zoomable visualization of the space which provides increasing detail with increasing zoom. “Tokens” and “placed tokens” can include extracted software tokens and/or synthesized software tokens in any combination.

Example 2 includes the subject matter of Example 1, and further specifies that: the network of relationships includes a hypergraph, at least one edge of which joins three or more of the software tokens.

Example 3 includes the subject matter of any of Examples 1-2, and further specifies that: at least some of the assigned tags indicate classes of the respective software tokens in the hierarchical software environment.

Example 4 includes the subject matter of any of Examples 1-3, and further specifies that: the assignment of at least one of the one or more tags is performed interactively.

Example 5 includes the subject matter of any of Examples 1-4, and further specifies that: the assignment of at least one of the one or more tags is performed by a trained machine learning tool.

Example 6 includes the subject matter of any of Examples 1-5, and further includes: rendering, on the visualization, a workflow as a graph having nodes including the tokens representing successive acts of the workflow.

Example 7 includes the subject matter of any of Examples 1-6, and further includes: rendering, on the visualization, a dataflow as a graph having edges traceable along data dependencies between two or more of the tokens.

Example 8 includes the subject matter of any of Examples 1-7, and further includes: rendering, on the visualization, a variation of a first graph of a flow, the variation passing through a synthesized token and omitting an extracted software token which is part of the first graph.

Example 9 includes the subject matter of any of Examples 1-8, and further includes: receiving user input to filter the visualization according to one or more criteria; and rendering the filtered visualization in response to the user input.

Example 10 includes the subject matter of any of Examples 1-9, and further includes: receiving a user selection including a rendered token on the visualization; and launching or transferring focus to a software application associated with the rendered token.

Example 11 includes the subject matter of any of Examples 1-10, and further specifies that: the space is two-dimensional.

Example 12 includes the subject matter of any of Examples 1-11, and further specifies that: at least some of the placed tokens (extracted and/or synthesized software tokens) have respective finite extents in the space; and the extent of a first placed token overlaps a second placed token.

Example 13 includes the subject matter of any of Examples 1-12, and further specifies that: at least some of the placed tokens (extracted and/or synthesized software tokens) have respective finite extents in the space; and as zoom is reduced, the rendering prioritizes display of tokens based in part on their respective finite extents.

Example 14 includes the subject matter of any of Examples 1-13, and further specifies that: the rendering prioritizes display of the extracted software tokens over display of the synthesized software tokens.

Example 15 is one or more computer-readable media storing instructions which, when executed by one or more hardware processors, cause the one or more hardware processors to perform the method of any of Examples 1-14.

Example 16 is a system including one or more hardware processors with memory coupled thereto; and the one or more computer-readable media of Example 15.

Example 17 is a system including: one or more hardware processors with memory coupled thereto; and computer-readable media storing instructions which, when executed by the one or more hardware processors, cause the one or more hardware processors to perform operations including: from a hierarchical software environment, extracting a sea of software tokens and a network of relationships among respective groups of the software tokens, wherein the network of relationships includes a hypergraph, at least one edge of the hypergraph joining three or more of the software tokens; assigning one or more tags to each of the software tokens; placing the software tokens in a space based at least partly on the assigned tags and at least partly on the extracted relationships, wherein at least some of the placed software tokens have respective finite extents in the space; synthesizing additional software tokens; placing the additional software tokens at positions intermediate between previously placed tokens, the tokens including the extracted software tokens and the synthesized software tokens, collectively; rendering a zoomable visualization of the space which provides increasing detail with increasing zoom; and receiving user input, and: in a first case for which the user input indicates that the visualization be filtered according to one or more criteria, rendering the filtered visualization in response to the user input; or in a second case for which the user input indicates selection of a rendered token on the visualization, launching or transferring focus to a software application associated with the rendered token.

Example 18 includes the subject matter of Example 17, and further specifies that the operations further include: assigning additional tags to the additional software tokens; and selecting, as zoom is decreased, a subset of the tokens to be retained in the rendered visualization, wherein the selecting is based at least partly on the respective tags assigned to the tokens.

### A Generalized Computer Environment

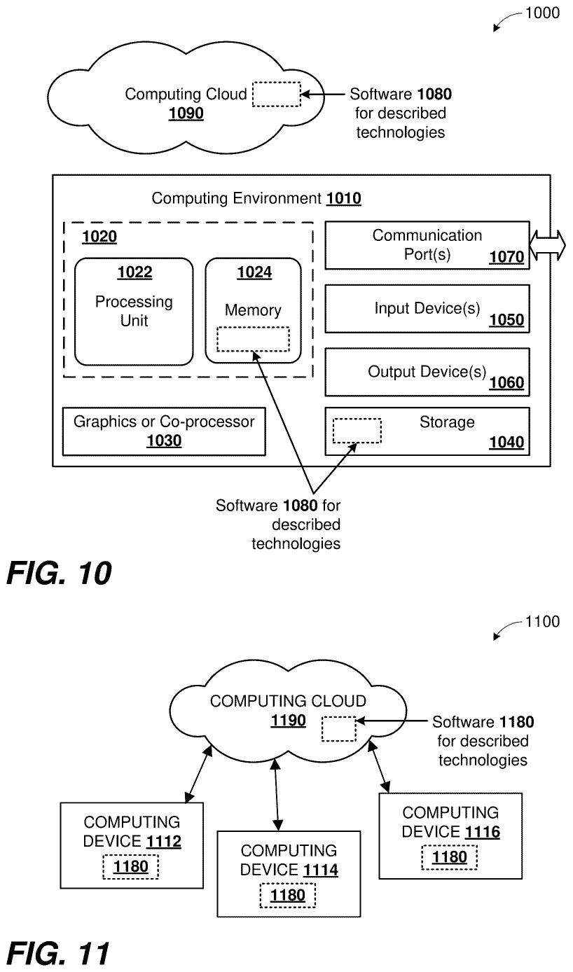

FIG. 10 illustrates a generalized example of a suitable computing system 1000 in which described examples, techniques, technologies, and workflows related to visualizing software tokens can be implemented according to disclosed technologies. The computing system 1000 is not intended to suggest any limitation as to scope of use or functionality of the present disclosure, as the innovations can be implemented in diverse general-purpose or special-purpose computing systems.

With reference to FIG. 10, computing environment 1010 includes one or more processing units 1022 and memory 1024. In FIG. 10, this basic configuration 1020 is included within a dashed line. Processing unit 1022 executes computer-executable instructions, such as for implementing any of the methods or objects described herein for visualizing software tokens, or various other architectures, software components, handlers, managers, modules, or services described herein. Processing unit 1022 can be a general-purpose central processing unit (CPU), a processor in an application-specific integrated circuit (ASIC), or any other type of processor. In a multi-processing system, multiple processing units execute computer-executable instructions to increase processing power. Computing environment 1010 can also include a graphics processing unit or co-processing unit 1030. Tangible memory 1024 can be volatile memory (e.g., registers, cache, or RAM), non-volatile memory (e.g., ROM, EEPROM, or flash memory), or some combination thereof, accessible by processing units 1022, 1030. The memory 1024 stores software 1080 implementing one or more innovations described herein, in the form of computer-executable instructions suitable for execution by the processing unit(s) 1022, 1030. The memory 1024 can also store records describing or characterizing software tokens, relationships therebetween, flows, content clusters, configuration data, data structures including data tables, working tables, change logs, output structures, data values, indices, or flags, as well as other operational data.

A computing system 1010 can have additional features, such as one or more of storage 1040, input devices 1050, output devices 1060, or communication ports 1070. An interconnection mechanism (not shown) such as a bus, controller, or network interconnects the hardware components of the computing environment 1010. Typically, operating system software (not shown) provides an operating environment for other software executing in the computing environment 1010, and coordinates activities of the hardware and software components of the computing environment 1010.

The tangible storage 1040 can be removable or non-removable, and can include magnetic disks, magnetic tapes or cassettes, CD-ROMs, DVDs, or any other medium which can be used to store information in a non-transitory way and which can be accessed within the computing environment 1010. The storage 1040 stores instructions of the software 1080 (including instructions and/or data) implementing one or more innovations described herein.

The input device(s) 1050 can be a mechanical, touch-sensing, or proximity-sensing input device such as a keyboard, mouse, pen, touchscreen, trackball, a voice input device, a scanning device, or another device that provides input to the computing environment 1010. The output device(s) 1060 can be a display, printer, speaker, optical disk writer, or another device that provides output from the computing environment 1010.

The communication port(s) 1070 enable communication over a communication medium to another computing device. The communication medium conveys information such as computer-executable instructions or other data in a modulated data signal. A modulated data signal is a signal that has one or more of its characteristics set or changed in such a manner as to encode information in the signal. By way of example, and not limitation, communication media can use an electrical, optical, RF, acoustic, or other carrier.

In some examples, computer system 1000 can also include a computing cloud 1090 in which instructions implementing all or a portion of the disclosed technologies are executed. Any combination of memory 1024, storage 1040, and computing cloud 1090 can be used to store software instructions or data of the disclosed technologies.

The present innovations can be described in the general context of computer-executable instructions, such as those included in program modules, being executed in a computing system on a target real or virtual processor. Generally, program modules or software components include routines, programs, libraries, software objects, classes, data structures, etc. that perform tasks or implement particular abstract data types. The functionality of the program modules can be combined or split between program modules as desired in various embodiments. Computer-executable instructions for program modules can be executed within a local or distributed computing system.

The terms “computing system,” “computing environment,” and “computing device” are used interchangeably herein. Unless the context clearly indicates otherwise, none of these terms implies any limitation on a type of computing system, computing environment, or computing device. In general, a computing system, computing environment, or computing device can be local or distributed, and can include any combination of special-purpose hardware, general-purpose hardware, and/or virtualized hardware, together with software implementing the functionality described herein. Virtual processors, virtual hardware, and virtualized devices are ultimately embodied in a hardware processor or another form of physical computer hardware, and thus include both software associated with virtualization and underlying hardware.

### Example Cloud Computing Environment

FIG. 11 depicts an example cloud computing environment 1100 in which the described technologies can be implemented. The cloud computing environment 1100 comprises a computing cloud 1190 containing resources and providing services. The computing cloud 1190 can comprise various types of cloud computing resources, such as computer servers, data storage repositories, networking resources, and so forth. The computing cloud 1190 can be centrally located (e.g., provided by a data center of an enterprise) or distributed (e.g., provided by various computing resources located at different sites, such as different data centers and/or located in different cities or countries).

The computing cloud 1190 can be operatively connected to various types of computing devices (e.g., client computing devices), such as computing devices 1112, 1114, and 1116, and can provide a range of computing services thereto. One or more of computing devices 1112, 1114, and 1116 can be computers (e.g., servers, virtual machines, embedded systems, desktop, or laptop computers), mobile devices (e.g., tablet computers, smartphones, or wearable appliances), or other types of computing devices. Communication links between computing cloud 1190 and computing devices 1112, 1114, and 1116 can be over wired, wireless, or optical links, or any combination thereof, and can be short-lived or long-lasting. Communication links can be continuous or sporadic. These communication links can be stationary or can move over time, being implemented over varying paths and having varying attachment points at each end. Computing devices 1112, 1114, and 1116 can also be connected to each other.

Computing devices 1112, 1114, and 1116 can utilize the computing cloud 1190 to obtain computing services and perform computing operations (e.g., data processing, data storage, and the like). Particularly, software 1180 for performing the described innovative technologies can be resident or executed in the computing cloud 1190, in computing devices 1112, 1114, and 1116, or in a distributed combination of cloud and computing devices.

### General Considerations

As used in this disclosure, the singular forms “a,” “an,” and “the” include the plural forms unless the surrounding language clearly dictates otherwise. Additionally, the terms “includes” and “incorporates” mean “comprises.” Further, the terms “coupled” or “attached” encompass mechanical, electrical, magnetic, optical, as well as other practical ways of coupling items together, and do not exclude the presence of intermediate elements between the coupled items. Furthermore, as used herein, the terms “or” and “and/or” mean any one item or combination of items in the phrase.

Although the operations of some of the disclosed methods are described in a particular, sequential order for convenient presentation, it should be understood that this manner of description encompasses rearrangement, unless a particular ordering is required by specific language set forth below. For example, operations described sequentially can in some cases be rearranged or performed concurrently. Moreover, for the sake of simplicity, the attached figures may not show the various ways in which the disclosed things and methods can be used in conjunction with other things and methods. Additionally, the description sometimes uses terms like “apply,” “assign,” “calculate,” “classify,” “combine,” “compare,” “compute,” “determine,” “display,” “evaluate,” “execute,” “extend,” “extract,” “extrapolate,” “filter,” “generalize,” “generate,” “identify,” “incorporate,” “increase,” “interpolate,” “launch,” “modify,” “obtain,” “optimize,” “output,” “perform,” “place,” “provide,” “receive,” “reduce,” “render,” “request,” “respond,” “return,” “select,” “send,” “speciate,” “store,” “synthesize,” “transfer,” “transmit,” “update,” “use,” or “zoom” to indicate computer operations in a computer system. These terms denote actual operations that are performed or controlled by a computer. The actual operations that correspond to these terms will vary depending on the particular implementation and are readily discernible by one of ordinary skill in the art.

Theories of operation, scientific principles, or other theoretical descriptions presented herein in reference to the apparatus or methods of this disclosure have been provided for the purposes of better understanding and are not intended to be limiting in scope. The apparatus and methods in the appended claims are not limited to those apparatus and methods that function in the manner described by such theories of operation.

In some examples, values, procedures, or apparatus may be referred to as “optimal,” “lowest,” “best,” “maximum,” “extremum,” or the like. It will be appreciated that such descriptions are intended to indicate that a selection among a few or among many alternatives can be made, and such selections need not be lower, better, less, or otherwise preferable to other alternatives not considered.

Any of the disclosed methods can be implemented as computer-executable instructions or a computer program product stored on one or more computer-readable storage media, such as tangible, non-transitory computer-readable storage media, and executed on a computing device (e.g., any available computing device, including tablets, smartphones, or other mobile devices that include computing hardware). Tangible computer-readable storage media are any available tangible media that can be accessed within a computing environment (e.g., one or more optical media discs such as DVD or CD, volatile memory components (such as DRAM or SRAM), or nonvolatile memory components (such as flash memory or hard drives)). By way of example, and with reference to FIG. 10, computer-readable storage media include memory 1024, and storage 1040. The terms computer-readable media or computer-readable storage media do not include signals and carrier waves. In addition, the terms computer-readable media or computer-readable storage media do not include communication ports (e.g., 1070) or communication media.

Any of the computer-executable instructions for implementing the disclosed techniques as well as any data created and used during implementation of the disclosed embodiments can be stored on one or more computer-readable storage media. The computer-executable instructions can be part of, for example, a dedicated software application or a software application that is accessed or downloaded via a web browser or other software application (such as a remote computing application). Such software can be executed, for example, on a single local computer (e.g., any suitable commercially available computer) or in a network environment (e.g., via the Internet, a wide-area network, a local-area network, a client-server network, a cloud computing network, or other such network) using one or more network computers.

For clarity, only certain selected aspects of the software-based implementations are described. Other details that are well known in the art are omitted. For example, it should be understood that the disclosed technologies are not limited to any specific computer language or program. For instance, the disclosed technologies can be implemented by software written in ABAP, Adobe Flash, Angular, C, C++, C #, Curl, Dart, Fortran, Go, Java, JavaScript, Julia, Lisp, Matlab, Octave, Perl, Python, R, Ruby, Rust, SAS, SPSS, WebAssembly, any derivatives thereof, or any other suitable programming language, or, in some examples, markup languages such as HTML or XML, or in any combination of suitable languages, libraries, and packages. Likewise, the disclosed technologies are not limited to any particular computer or type of hardware. Certain details of suitable computer, hardware, and communication technologies are well known and need not be set forth in detail in this disclosure.

Furthermore, any of the software-based embodiments (comprising, for example, computer-executable instructions for causing a computer to perform any of the disclosed methods) can be uploaded, downloaded, or remotely accessed through a suitable communication means. Such suitable communication means include, for example, the Internet, the World Wide Web, an intranet, software applications, cable (including fiber optic cable), magnetic communications, electromagnetic communications (including RF, microwave, infrared, and optical communications), electronic communications, or other such communication means.

The disclosed methods, apparatus, and systems should not be construed as limiting in any way. Instead, the present disclosure is directed toward all novel and nonobvious features and aspects of the various disclosed embodiments, alone and in various combinations and sub-combinations with one another. The disclosed methods, apparatus, and systems are not limited to any specific aspect or feature or combination thereof, nor do the disclosed embodiments require that any one or more specific advantages be present or problems be solved. The technologies from any example can be combined with the technologies described in any one or more of the other examples.

In view of the many possible embodiments to which the principles of the disclosed technologies may be applied, it should be recognized that the illustrated embodiments are only preferred examples and should not be taken as limiting the scope of the claims. Rather, the scope of the claimed subject matter is defined by the following claims. I therefore claim all that comes within the scope and spirit of these claims.

I claim:

1. A method, comprising:
with one or more computers:
from a hierarchical software environment, extracting a sea of software tokens and a network of relationships among respective groups of the software tokens;
assigning one or more tags to each of the software tokens;
placing the software tokens in a space based at least partly on the assigned tags and at least partly on the extracted relationships;
synthesizing additional software tokens;
placing the additional software tokens at positions intermediate between previously placed tokens, the tokens comprising the extracted software tokens and the synthesized software tokens, collectively; and
rendering a zoomable visualization of the space which provides increasing detail with increasing zoom.

2. The method of claim 1, wherein:
the network of relationships comprises a hypergraph, at least one edge of which joins three or more of the software tokens.

3. The method of claim 1, wherein:
at least some of the assigned tags indicate classes of the respective software tokens in the hierarchical software environment.

4. The method of claim 1, wherein:
the assignment of at least one of the one or more tags is performed interactively.

5. The method of claim 1, wherein:
the assignment of at least one of the one or more tags is performed by a trained machine learning tool.

6. The method of claim 1, further comprising:
rendering, on the visualization, a workflow as a graph having nodes comprising the tokens representing successive acts of the workflow.

7. The method of claim 1, further comprising:
rendering, on the visualization, a dataflow as a graph having edges traceable along data dependencies between two or more of the tokens.

8. The method of claim 1, further comprising:
rendering, on the visualization, a variation of a first graph of a flow, the variation passing through a synthesized token and omitting an extracted software token which is part of the first graph.

9. The method of claim 1, further comprising:
receiving user input to filter the visualization according to one or more criteria; and
rendering the filtered visualization in response to the user input.

10. The method of claim 1, further comprising:
receiving a user selection comprising a rendered token on the visualization; and
launching or transferring focus to a software application associated with the rendered token.

11. One or more computer-readable media storing instructions which, when executed by one or more hardware processors, cause the one or more hardware processors to perform operations comprising:
from a hierarchical software environment, extracting a sea of software tokens and a network of relationships among respective groups of the software tokens;
assigning one or more tags to each of the software tokens;
placing the software tokens in a space based at least partly on the assigned tags and at least partly on the extracted relationships;
synthesizing additional software tokens;
placing the additional software tokens at positions intermediate between previously placed tokens, the tokens comprising the extracted software tokens and the synthesized software tokens, collectively; and
rendering a zoomable visualization of the space which provides increasing detail with increasing zoom.

12. The one or more computer-readable media of claim 11, wherein:
the network of relationships comprises a hypergraph, at least one edge of which joins three or more of the software tokens.

13. The one or more computer-readable media of claim 11, wherein:
at least some of the placed tokens have respective finite extents in the space; and
the extent of a first placed token overlaps a second placed token.

14. The one or more computer-readable media of claim 11, wherein:
at least some of the placed tokens have respective finite extents in the space; and
as zoom is reduced, the rendering prioritizes display of tokens based in part on their respective finite extents.

15. The one or more computer-readable media of claim 11, wherein:
the rendering prioritizes display of the extracted software tokens over display of the synthesized software tokens.

16. The one or more computer-readable media of claim 11, wherein the operations further comprise:
rendering, on the visualization, a variation of a first graph of a flow, the variation passing through a synthesized token and omitting an extracted software token which is part of the first graph.

17. The one or more computer-readable media of claim 11, wherein the operations further comprise:
receiving user input to filter the visualization according to one or more criteria; and
rendering the filtered visualization in response to the user input.

18. The one or more computer-readable media of claim 11, wherein the operations further comprise:
receiving a user selection comprising a rendered token on the visualization; and
launching or transferring focus to a software application associated with the rendered token.

19. A system comprising:
one or more hardware processors with memory coupled thereto; and
computer-readable media storing instructions which, when executed by the one or more hardware processors, cause the one or more hardware processors to perform operations comprising:
from a hierarchical software environment, extracting a sea of software tokens and a network of relationships among respective groups of the software tokens, wherein the network of relationships comprises a hypergraph, at least one edge of the hypergraph joining three or more of the software tokens;
assigning one or more tags to each of the software tokens;
placing the software tokens in a space based at least partly on the assigned tags and at least partly on the extracted relationships, wherein at least some of the placed software tokens have respective finite extents in the space;
synthesizing additional software tokens;
placing the additional software tokens at positions intermediate between previously placed tokens, the tokens comprising the extracted software tokens and the synthesized software tokens, collectively;
rendering a zoomable visualization of the space which provides increasing detail with increasing zoom; and
receiving user input, and:
in a first case for which the user input indicates that the visualization be filtered according to one or more criteria, rendering the filtered visualization in response to the user input; or
in a second case for which the user input indicates selection of a rendered token on the visualization, launching or transferring focus to a software application associated with the rendered token.

20. The system of claim 19, wherein the operations further comprise:
assigning additional tags to the additional software tokens; and
selecting, as zoom is decreased, a subset of the tokens to be retained in the rendered visualization, wherein the selecting is based at least partly on the respective tags assigned to the tokens.
